(19) United States
(12) Patent Application Publication
(10) Pub. No.: US 2022/0261659 A1
(43) Pub. Date: Aug. 18, 2022

(54) Method and Apparatus for Determining Neural Network

(71) Applicant: Huawei Technologies Co., Ltd., Shenzhen (CN)

(72) Inventors: Hang Xu, Hong Kong (CN); Zhenguo Li, Hong Kong (CN); Wei Zhang, London (GB); Xiaodan Liang, Guangzhou (CN); Chenhan Jiang, Hong Kong (CN)

(21) Appl. No.: 17/738,685

(22) Filed: May 6, 2022

Related U.S. Application Data
(63) Continuation of application No. PCT/CN2020/095409, filed on Jun. 10, 2020.

(30) Foreign Application Priority Data
Nov. 8, 2019 (CN) 201911090334.1

(51) Int. Cl. G06N 3/10; G06N 3/08; G06N 3/04

(52) U.S. Cl. CPC G06N 3/10; G06N 3/0454; G06N 3/08

(57) ABSTRACT

This application provides a method and related apparatus for determining a neural network in the field of artificial intelligence. The method includes: obtaining a plurality of initial search spaces; determining M candidate neural networks based on the plurality of initial search spaces, where the candidate neural network includes a plurality of candidate subnetworks, the plurality of candidate subnetworks belong to the plurality of initial search spaces, and any two of the plurality of candidate subnetworks belong to different initial search spaces; evaluating the M candidate neural networks to obtain M evaluation results; and determining N candidate neural networks from the M candidate neural networks based on the M evaluation results, and determining N first target neural networks based on the N candidate neural networks. According to the method and the related apparatus provided in this application, a combined neural network with relatively high performance can be obtained.

### CROSS-REFERENCE TO RELATED APPLICATIONS

This application is a continuation of International Application No. PCT/CN2020/095409, filed on Jun. 10, 2020, which claims priority to Chinese Patent Application No. 201911090334.1, filed on Nov. 8, 2019. The disclosures of the aforementioned applications are hereby incorporated by reference in their entireties

### TECHNICAL FIELD

This application relates to the field of artificial intelligence, and more specifically, to a method and an apparatus for determining a neural network.

### BACKGROUND

A neural network is a type of mathematical computing model that simulates structures and functions of a biological neural network (a central nervous system of an animal). One neural network may include a plurality of layers of neural networks with different functions, and each layer includes parameters and calculation formulas. Different layers in the neural network have different names based on different calculation formulas or different functions. For example, a layer for convolution calculation is referred to as a convolutional layer. The convolutional layer is commonly used to perform feature extraction on an input signal (for example, an image).

A neural network used in some application scenarios may be a combination of a plurality of neural networks. For example, a neural network used to execute an object detection task may be a combination of a residual network (residual networks, ResNet), a multi-level feature extraction model, and a region proposal network (RPN).

Therefore, how to obtain a neural network formed by a combination of a plurality of neural networks is a technical problem to be resolved urgently.

### SUMMARY

This application provides a method and related apparatus for determining a neural network, to obtain a combined neural network with relatively high performance.

According to a first aspect, this application provides a method for determining a neural network, including: obtaining a plurality of initial search spaces, where the initial search space includes one or more neural networks, neural networks in any two of the initial search spaces have different functions, and any two neural networks in a same initial search space have a same function but different network structures; determining M candidate neural networks based on the plurality of initial search spaces, where the candidate neural network includes a plurality of candidate subnetworks, the plurality of candidate subnetworks belong to the plurality of initial search spaces, any two of the plurality of candidate subnetworks belong to different initial search spaces, and M is a positive integer; evaluating the M candidate neural networks to obtain M evaluation results; and determining N candidate neural networks from the M candidate neural networks based on the M evaluation results, and determining N first target neural networks based on the N candidate neural networks. Each of the N first target neural networks includes a plurality of target subnetworks, each of the N candidate neural networks includes a plurality of candidate subnetworks, the N first target neural networks are in a one-to-one correspondence with the N candidate neural networks, the plurality of target subnetworks included in each first target neural network are in a one-to-one correspondence with a plurality of candidate subnetworks included in a corresponding candidate neural network, a block included in each target subnetwork in each first target neural network is the same as a block included in a corresponding candidate subnetwork, and N is a positive integer less than or equal to M.

In this method, after obtaining the candidate neural network from the plurality of initial search spaces through sampling, the entire candidate neural network is evaluated, and then the first target neural network is determined based on an evaluation result and the candidate neural network. Compared with a manner of determining the first target neural network based on evaluation results of candidate subnetworks after the candidate subnetworks are evaluated separately, in the manner of determining the first target neural network based on the evaluation result of the entire candidate neural network after the candidate neural network is obtained through sampling, a combination mode between the candidate subnetworks is fully considered, and the first target neural network with better performance may be obtained.

In some possible implementations, the evaluation result of the candidate neural network includes one or more of the following: an operating speed, accuracy, a quantity of parameters, or floating-point operations.

In some possible implementations, the determining N candidate neural networks from the M candidate neural networks based on the M evaluation results includes: determining, based on the M evaluation results, N candidate neural networks whose evaluation results meet a task requirement from the M candidate neural networks as the N candidate neural networks.

For example, N candidate neural networks whose operating speeds and/or accuracy meet/meets a preset task requirement in the M candidate neural networks are determined as the N candidate neural networks.

In some possible implementations, the evaluation result of the candidate neural network includes the operating speed and accuracy. The determining N candidate neural networks from the M candidate neural networks based on the M evaluation results includes: determining Pareto optimal solutions of the M candidate neural networks as the N candidate neural networks based on the M evaluation results and by using the operating speed and accuracy as an objective.

Because the N candidate neural networks obtained in this implementation are the Pareto optimal solutions of the M candidate neural networks, performance of the N candidate neural networks is better than performance of other candidate neural networks, and performance of the N first target neural networks determined based on the N candidate neural networks is also better.

In some possible implementations, the determining N first target neural networks based on the N candidate neural networks includes: determining the N candidate neural networks as the N first target neural networks.

In some possible implementations, the determining N first target neural networks based on the N candidate neural networks includes: determining a plurality of target search spaces based on a plurality of candidate subnetworks in an i^{th} candidate neural network in the N candidate neural networks, where the plurality of target search spaces are in a one-to-one correspondence with the plurality of candidate subnetworks in the i^{th} candidate neural network, each of the plurality of target search spaces includes one or more neural networks, and a block included in each neural network in each target search space is the same as a block included in a candidate subnetwork corresponding to each target search space; and determining an i^{th} first target neural network in the N first target neural networks based on the plurality of target search spaces, where a plurality of target subnetworks in the i^{th} first target neural network belong to the plurality of target search spaces, any two of the plurality of target subnetworks in the i^{th} first target neural network belong to different target search spaces, and i is a positive integer less than or equal to N.

In other words, the first target neural network with better performance is obtained by searching again without changing the block.

In some possible implementations, the method further includes: determining N second target neural networks based on the N first target neural networks, where an i^{th} second target neural network in the N second target neural networks is obtained by performing one or more of the following processing on the i^{th} first target neural network: adding a group normalization layer after a convolutional layer in the target subnetwork in the i^{th} first target neural network; adding a group normalization layer after a fully connected layer in the target subnetwork in the i^{th} first target neural network; and performing normalization processing on a weight of the convolutional layer in the target subnetwork in the i^{th} first target neural network, where i is a positive integer less than or equal to N.

This implementation can improve performance of the second target neural network and increase a training speed of the second target neural network.

In some possible implementations, the method further includes: evaluating the N second target neural networks to obtain evaluation results of the N second target neural networks. The N evaluation results may be used to select a more appropriate second target neural network from the N second target neural networks based on the task requirement, to improve task completion quality.

In some possible implementations, the evaluating the N second target neural networks to obtain evaluation results of the N second target neural networks includes: randomly initializing a network parameter in the i^{th} second target neural network; training the i^{th} second target neural network based on training data; and testing the i^{th} trained second target neural network based on test data, to obtain an evaluation result of the i^{th} trained second target neural network.

In some possible implementations, the first target neural network is used for object detection; the plurality of initial search spaces include a first initial search space, a second initial search space, a third initial search space, and a fourth initial search space; the first initial search space includes residual networks of different depths, next-dimension residual networks (ResNext) of different depths, and/or mobile networks (MobileNet) of different depths; the second initial search space includes a connection path of features at different levels; the third initial search space includes a common region proposal network (region proposal net, RPN) and/or a guided anchoring region proposal network (region proposal by guided anchoring, GA-RPN); and the fourth initial search space includes a one-stage detection head network (Retina-head), a fully connected detection head network, a fully convolutional detection head network, and/or a cascade detection head network (Cascade-head).

In some possible implementations, the first target neural network is used for image classification; the plurality of initial search spaces include a first initial search space and a second initial search space; the first initial search space includes residual networks of different depths, ResNexts of different depths, and/or densely connected networks (DenseNet) of different widths; and a neural network in the second initial search space includes a fully connected layer.

In some possible implementations, the first target neural network is used for image segmentation; the plurality of initial search spaces include a first initial search space, a second initial search space, and a third initial search space; the first initial search space includes residual networks of different depths, ResNexts of different depths, and/or high-resolution networks of different widths; the second initial search space includes an atrous spatial pyramid pooling network, a pyramid pooling network, and/or a network including a dense prediction unit; and the third initial search space includes a U-Net model and/or a fully convolutional network.

According to a second aspect, this application provides an apparatus for determining a neural network. The apparatus includes: an obtaining module, configured to obtain a plurality of initial search spaces, where the initial search space includes one or more neural networks, neural networks in any two of the initial search spaces have different functions, and any two neural networks in a same initial search space have a same function but different network structures; a determining module, configured to determine M candidate neural networks based on the plurality of initial search spaces, where the candidate neural network includes a plurality of candidate subnetworks, the plurality of candidate subnetworks belong to the plurality of initial search spaces, any two of the plurality of candidate subnetworks belong to different initial search spaces; and an evaluation module, configured to evaluate the M candidate neural networks to obtain M evaluation results, where M is a positive integer. The determining module is further configured to: determine N candidate neural networks from the M candidate neural networks based on the M evaluation results, and determine N first target neural networks based on the N candidate neural networks. Each of the N candidate neural networks includes a plurality of candidate subnetworks, each of the N first target neural networks includes a plurality of target subnetworks, the N first target neural networks are in a one-to-one correspondence with the N candidate neural networks, the plurality of target subnetworks included in each first target neural network are in a one-to-one correspondence with a plurality of candidate subnetworks included in a corresponding candidate neural network, a block included in each target subnetwork in each first target neural network is the same as a block included in a corresponding candidate subnetwork, and N is a positive integer less than or equal to M.

In some possible implementations, the evaluation result of the candidate neural network includes one or more of the following: an operating speed, accuracy, a quantity of parameters, or floating-point operations.

In some possible implementations, the evaluation result of the candidate neural network includes the operating speed and accuracy. The determining module is specifically configured to: determine Pareto optimal solutions of the M candidate neural networks as the N candidate neural networks based on the M evaluation results and by using the operating speed and accuracy as an objective.

In some possible implementations, the determining module is specifically configured to: determine a plurality of target search spaces based on a plurality of candidate subnetworks in an i^{th} candidate neural network in the N candidate neural networks, where the plurality of target search spaces are in a one-to-one correspondence with the plurality of candidate subnetworks in the i^{th} candidate neural network, each of the plurality of target search spaces includes one or more neural networks, and a block included in each neural network in each target search space is the same as a block included in a candidate subnetwork corresponding to each target search space; and determine an i^{th} first target neural network in the N first target neural networks based on the plurality of target search spaces, where a plurality of target subnetworks in the i^{th} first target neural network belong to the plurality of target search spaces, any two of the plurality of target subnetworks in the i^{th} first target neural network belong to different target search spaces, and i is a positive integer less than or equal to N.

In some possible implementations, the determining module is further configured to: determine N second target neural networks based on the N first target neural networks, where an i^{th} second target neural network in the N second target neural networks is obtained by performing one or more of the following processing on the i^{th} first target neural network: adding a group normalization layer after a convolutional layer in the target subnetwork in the i^{th} first target neural network; adding a group normalization layer after a fully connected layer in the target subnetwork in the i^{th} first target neural network; and performing normalization processing on a weight of the convolutional layer in the target subnetwork in the i^{th} first target neural network, where i is a positive integer less than or equal to N.

In some possible implementations, the evaluation module is further configured to evaluate the N second target neural networks to obtain evaluation results of the N second target neural networks.

In some possible implementations, the evaluation module is specifically configured to: randomly initialize a network parameter in the i^{th} second target neural network; train the i^{th} second target neural network based on training data; and test the i^{th} trained second target neural network based on test data, to obtain an evaluation result of the i^{th} trained second target neural network.

In some possible implementations, the first target neural network is used for object detection; the plurality of initial search spaces include a first initial search space, a second initial search space, a third initial search space, and a fourth initial search space; the first initial search space includes residual networks of different depths, next-dimension residual networks of different depths, and/or mobile networks of different depths; the second initial search space includes a connection path of features at different levels; the third initial search space includes a common region proposal network and/or a guided anchoring region proposal network; and the fourth initial search space includes a one-stage detection head network, a fully connected detection head network, a fully convolutional detection head network, and/or a cascade detection head network.

In some possible implementations, the first target neural network is used for image classification; the plurality of initial search spaces include a first initial search space and a second initial search space; the first initial search space includes residual networks of different depths, next-dimension residual networks of different depths, and/or densely connected networks of different widths; and a neural network in the second initial search space includes a fully connected layer.

In some possible implementations, the first target neural network is used for image segmentation; the plurality of initial search spaces include a first initial search space, a second initial search space, and a third initial search space; the first initial search space includes residual networks of different depths, next-dimension residual networks of different depths, and/or high-resolution networks of different widths; the second initial search space includes an atrous spatial pyramid pooling network, a pyramid pooling network, and/or a network including a dense prediction unit; and the third initial search space includes a U-Net model and/or a fully convolutional network.

The apparatus includes: a memory, configured to store a program; and a processor, configured to execute the program stored in the memory. When the program stored in the memory is executed, the processor is configured to perform the method in the second aspect.

According to a fourth aspect, a computer-readable medium is provided. The computer-readable medium stores instructions executable by a device, and the instructions are used to implement the method in the first aspect.

According to a fifth aspect, a computer program product including instructions is provided. When the computer program product is run on a computer, the computer is enabled to perform the method in the first aspect.

According to a sixth aspect, a chip is provided, where the chip includes a processor and a data interface, and the processor reads, by using the data interface, instructions stored in a memory, to perform the method in the first aspect.

Optionally, in an implementation, the chip may further include the memory, the memory stores the instructions, the processor is configured to execute the instructions stored in the memory, and when the instructions are executed, the processor is configured to perform the method in the first aspect.

### BRIEF DESCRIPTION OF DRAWINGS

FIG. 1 is an example flowchart of a method for determining a neural network according to this application;

FIG. 2 is an example diagram of an initial search space of a neural network used to execute an object detection task according to this application;

FIG. 3 is an example diagram of an initial search space of a neural network used to execute an image classification task according to this application;

FIG. 4 is an example diagram of an initial search space of a neural network used to execute an image segmentation task according to this application;

FIG. 5 is another example flowchart of a method for determining a neural network according to this application;

FIG. 6 is an example diagram of a Pareto front of a candidate neural network according to this application;

FIG. 7 is another example flowchart of a method for determining a neural network according to this application;

FIG. 8 is another example flowchart of a method for determining a neural network according to this application;

FIG. 9 is an example diagram of a structure of an apparatus for determining a neural network according to an embodiment of this application;

FIG. 10 is an example diagram of a structure of an apparatus for determining a neural network according to an embodiment of this application; and

FIG. 11 is another example diagram of a Pareto front of a candidate neural network according to this application.

### DESCRIPTION OF EMBODIMENTS

For ease of understanding, the following describes concepts related to this application.

(1) Neural Network

The neural network may include a neuron. The neuron may be an operation unit that uses xₛ and an intercept of 1 as input. Output of the operation unit may be as follows:

h_{W,b}(x)=ƒ(W^{T}x)=ƒ(Σₛ₌₁ⁿWₛxₛ+b) (1-1)

Herein, s=1, 2, . . . , n, n is a natural number greater than 1, Wₛ represents a weight of xₛ, b represents a bias of the neuron, and f represents an activation function (activation functions) of the neuron, where the activation function is used to introduce a non-linear characteristic into the neural network, to convert an input signal in the neuron into an output signal. The output signal of the activation function may be used as input of a next convolutional layer, and the activation function may be a sigmoid function. The neural network is a network constituted by connecting a plurality of single neurons together. To be specific, output of a neuron may be input of another neuron. Input of each neuron may be connected to a local receptive field of a previous layer to extract a feature of the local receptive field. The local receptive field may be a region including several neurons.

(2) Deep Neural Network

The deep neural network (deep neural network, DNN) is also referred to as a multi-layer neural network, and may be understood as a neural network having a plurality of hidden layers. The DNN is divided based on positions of different layers. Neural networks inside the DNN may be classified into three types: an input layer, a hidden layer, and an output layer. Generally, the first layer is the input layer, the last layer is the output layer, and the middle layer is the hidden layer. Layers are fully connected. To be specific, any neuron in an i^{th} layer is necessarily connected to any neuron in an (i+1)^{th} layer.

Although the DNN seems complex, the DNN is actually not complex in terms of work at each layer, and is simply represented as the following linear relationship expression: \vec{y}=α(W\vec{x}+\vec{b}), where \vec{x} is an input vector, \vec{y} is an output vector, \vec{b} is a bias vector, W is a weight matrix (which is also referred to as a coefficient), and α( ) is an activation function. At each layer, the output vector \vec{x} is obtained by performing such a simple operation on the input vector ŷ. Due to a large quantity of DNN layers, quantities of coefficients W and bias vectors \vec{b} are also large. Definitions of the parameters in the DNN are as follows: The coefficient W is used as an example. It is assumed that in a DNN with three layers, a linear coefficient from the fourth neuron at the second layer to the second neuron at the third layer is defined as W₂₄³. A superscript 3 represents a number of a layer in which the coefficient W is located, and a subscript corresponds to an index 2 of the third layer for output and an index 4 of the second layer for input.

In conclusion, a coefficient from a k^{th} neuron at an (L−1)^{th} layer to a j^{th} neuron at an L^{th} layer is defined as Wⱼₖ^{L}.

It should be noted that the input layer has no parameter W. In the deep neural network, more hidden layers make the network more capable of describing a complex case in the real world. Theoretically, a model with more parameters has higher complexity and a larger “capacity”. It indicates that the model can complete a more complex learning task. Training of the deep neural network is a process of learning a weight matrix, and a final objective of the training is to obtain a weight matrix of all layers of a trained deep neural network (a weight matrix formed by vectors W of many layers).

(3) Convolutional Neural Network

The convolutional neural network (convolutional neuron network, CNN) is a deep neural network with a convolutional structure. The convolutional neural network includes a feature extractor including a convolutional layer and a sub-sampling layer. The feature extractor may be considered as a filter. The convolutional layer is a neuron layer that performs convolution processing on an input signal that is in the convolutional neural network. In the convolutional layer of the convolutional neural network, one neuron may be connected to only a part of neurons in a neighboring layer. A convolutional layer generally includes several feature planes, and each feature plane may include some neurons arranged in a rectangle. Neurons of a same feature plane share a weight, and the shared weight herein is a convolution kernel. Sharing the weight may be understood as that a manner of extracting image information is unrelated to a position. The convolution kernel may be initialized in a form of a matrix of a random size. In a training process of the convolutional neural network, an appropriate weight may be obtained for the convolution kernel through learning. In addition, sharing the weight is advantageous because connections between layers of the convolutional neural network are reduced, and a risk of overfitting is reduced.

(4) Loss Function

In a process of training a deep neural network, because it is expected that an output of the deep neural network is as close as possible to a value that is actually expected to be predicted, a predicted value of a current network and a target value that is actually expected may be compared, and then, a weight vector of each layer of neural network is updated based on a difference between the two (certainly, there is usually an initialization process before the first update, that is, a parameter is preconfigured for each layer in the deep neural network). For example, if the predicted value of the network is higher, the weight vector is adjusted to obtain a lower predicted value. The weight vector is continuously adjusted until the deep neural network can predict the target value that is actually expected or a value that is very close to the target value that is actually expected. Therefore, “how to obtain, through comparison, a difference between the prediction value and the target value” needs to be predefined. This is a loss function (loss function) or an objective function (objective function). The loss function and the objective function are important equations used to measure the difference between the prediction value and the target value. The loss function is used as an example. A higher output value (loss) of the loss function indicates a larger difference. Therefore, training of the deep neural network becomes a process of reducing the loss as much as possible.

(5) Back Propagation Algorithm

In a training process, a neural network may correct values of parameters in an initial neural network model by using an error back propagation (back propagation, BP) algorithm, so that a reconstruction error loss of the neural network model becomes increasingly smaller. Specifically, an input signal is forward transferred until an error loss occurs in output, and the parameters in the initial neural network model are updated based on back propagation error loss information, so that the error loss is reduced. The back propagation algorithm is a back propagation motion mainly dependent on the error loss, and aims to obtain parameters of an optimal neural network model, for example, a weight matrix.

(6) Pareto Solution

A Pareto (Pareto) solution is also referred to as a nondominated solution (nondominated solutions). For a multi-objective case, because objectives are conflicting and equally good, a solution that is best for a specific objective may be the worst for another objective. The solution is referred to as a nondominated solution or Pareto solution, if none of the objectives can be improved without degrading at least one other objective.

Pareto optimality (Pareto Optimality) is a situation of resource allocation in which no objective can be better off without making another objective worse off. Pareto optimality is also referred to as Pareto efficiency or Pareto improvement.

A set of objective optimal solutions is referred to as a Pareto optimal set. A surface formed by the optimal set on a space is referred to as a Pareto front surface.

For example, when an operating speed and accuracy of a neural network are used as an objective, when an operating speed of one neural network is better than an operating speed of another neural network, accuracy of the neural network may be poor; and when accuracy of the neural network is better than accuracy of another neural network, the operating speed of the neural network may be poor. If prediction accuracy of a neural network cannot be improved without degrading operating accuracy of the neural network, the neural network may be referred to as a Pareto optimal solution with the operating accuracy and prediction accuracy as the objective.

(7) Backbone (Backbone) Network

A backbone network is used to extract features of an input image to obtain a multi-level (multi-scale) feature of the image. Common backbone networks include ResNet, ResNext, MobileNet, or DenseNet of different depths. A main difference between the backbone networks of different series lies in that basic units of the component networks are different. For example, the ResNet series includes ResNet-50, ResNet-101, and ResNet-152, a basic unit of which is a bottleneck network block. ResNet-50 includes 16 bottleneck network blocks, ResNet-101 includes 33 bottleneck network blocks, and ResNet-152 includes 50 bottleneck network blocks. A difference between the ResNext series and the ResNet series lies in that a basic unit of the ResNet series is a group-convolutional bottleneck network block rather than the bottleneck network block. A basic unit of the MobileNet series is depthwise separable convolution. A basic unit of the DenseNet series is a dense unit module and a transition network module.

(8) Multi-Level Feature Extraction Network (Neck)

A multi-level feature extraction network is used to filter and fuse a multi-scale feature to generate more compact and expressive feature vectors. The multi-level feature extraction network may include a fully convolutional pyramid network connected with different scales, an atrous spatial pyramid pooling (atrous spatial pyramid pooling, ASPP) network, a pyramid pooling network, or a network including a dense prediction unit.

(9) Prediction Module

A prediction module is configured to output a prediction result related to an application task.

The prediction module may include a head prediction network for converting features into a prediction result that finally meets a task requirement. For example, a prediction result finally output in an image classification task is a vector including a probability that an input image belongs to each category. A prediction result in an object detection task is coordinates, of an input image, of all candidate target boxes existing in the input image and a probability that the candidate target boxes belong to each category. The prediction module in an image segmentation task needs to output a pixel-level classification probability graph of an image.

The head prediction network may include a Retina-head, a fully connected detection head network, a Cascade-head, a U-Net model, or a fully convolutional detection head network.

When the prediction module is used for an object detection task in a computer vision task, the prediction module may include a region proposal network (region proposal network, RPN) and the head prediction network.

The RPN is a component module in a two-stage detection network, and is used to generate a fast regression classifier of a rough target location and classmark information. The RPN mainly includes two branches, where the first branch classifies the foreground and the background of each anchor point, and the second branch calculates an offset of a bounding box relative to the anchor point.

Usually, a two-layer simple network including a binary classifier and bounding box regression is used to implement the RPN. Bounding box regression is a regression model used for object detection. A regression window that has a smaller value of a loss function and that is closer to a real window is searched for near a target location obtained by a sliding window.

In this case, the head prediction network is used to further optimize a classification detection result obtained by the RPN, and is usually implemented by a multi-layer network that is more complex than the RPN. A combination of the RPN and the head prediction network enables an object detection system to quickly remove a large quantity of invalid image regions and to focus on meticulous detection of more potential image regions, thereby achieving a fast and good effect.

The method and the apparatus of this application may be applied to many fields of artificial intelligence, for example, fields such as smart manufacturing, smart transportation, smart home, smart health care, smart security protection, autonomous driving, and a safe city.

Specifically, a method and an apparatus in this application may be specifically applied to fields requiring a (deep) neural network, such as autonomous driving, image classification, image segmentation, object detection, image retrieval, image semantic segmentation, image quality enhancement, image super-resolution, and natural language processing.

For example, a neural network applicable to album classification obtained by using the method in this application, that is, a neural network for album classification, may be used to classify pictures, to label the pictures of different categories, so as to facilitate viewing and searching by a user. In addition, classification labels of the images may also be provided for an album management system to perform classification management. This saves management time of the user, improves album management efficiency, and improves user experience.

For another example, the method in this application is used to obtain a neural network that can detect an object such as a pedestrian, a vehicle, a traffic sign, or a lane line, so that an autonomous vehicle can travel on a road more safely.

For another example, a neural network that can be used for image object segmentation is obtained by using the method in this application, to understand content of a currently photographed image based on a segmentation result, and provide a decision basis for rendering a photographing effect, thereby providing an optimal image rendering effect for the user.

The following describes technical solutions in this application with reference to the accompanying drawings.

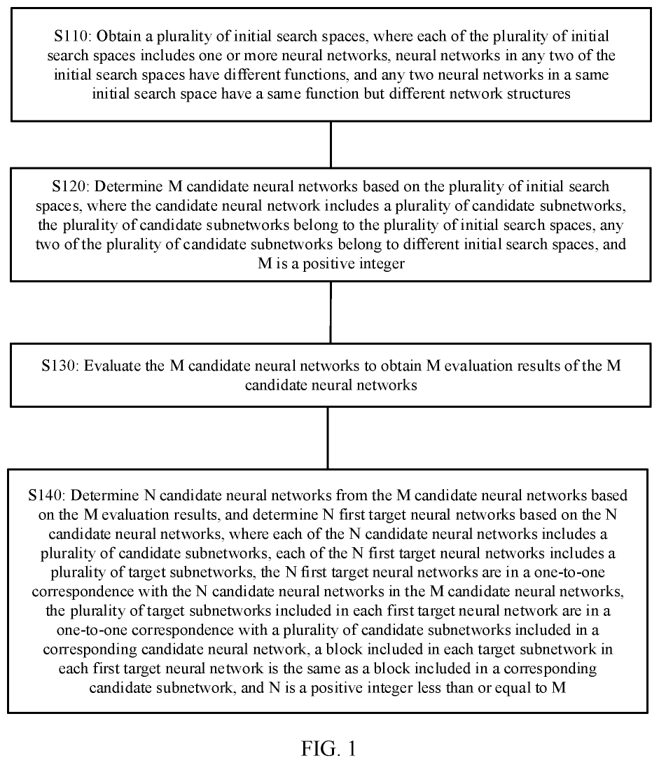

FIG. 1 is an example flowchart of a method for determining a neural network according to this application. The method includes S110 to S140.

S110: Obtain a plurality of initial search spaces, where each of the plurality of initial search spaces includes one or more neural networks, neural networks in any two of the initial search spaces have different functions, and any two neural networks in a same initial search space have a same function but different network structures.

At least one of the plurality of initial search spaces includes a plurality of neural networks.

In this embodiment of this application, a network structure of the neural network may include one or more stages (stage), and each stage may include at least one block (block). The block may include basic atoms in a convolutional neural network. The basic atoms include: a convolutional layer, a pooling layer, a fully connected layer, a nonlinear activation layer, or the like. The block may also be referred to as a basic unit or a basic module.

In a convolutional neural network, features usually exist in a three-dimensional form (length, width, and depth). One feature may be considered as a superposition of a plurality of two-dimensional features, where each two-dimensional feature of the feature may be referred to as a feature map. Alternatively, a feature map (a two-dimensional feature) of the feature may be referred to as a channel of the feature. The length and width of the feature map may also be referred to as resolution of the feature map.

When the neural network includes a plurality of stages, quantities of blocks in different stages may be different. Similarly, resolution of input feature maps and resolution of output feature maps processed at different stages may also be different.

When one stage in the neural network includes a plurality of blocks, quantities of channels of different blocks may be different. It should be understood that the quantity of channels of the block may also be referred to as the width of the block. Similarly, resolution of input feature maps and resolution of output feature maps processed by different blocks may also be different.

That any two neural networks have different network structures may include: quantities of stages included in the any two neural networks, quantities of blocks in the stages, quantities of channels of the blocks, resolution of input feature maps of the stages, resolution of output feature maps of the stages, resolution of input feature maps of the blocks, and/or resolution of output feature maps of the blocks are different.

Usually, the initial search space is determined based on a target task. In other words, the target task needs to be determined first; then, it is determined, based on the target task, neural networks having specific functions that can be combined to form a target neural network required to implement the target task; and an initial search space including the neural networks having the functions is constructed.

The following describes an implementation of determining the initial search space by using an example in which the target task is a high-level (high-level) computer vision task.

A target neural network for completing the high-level computer vision task may be a convolutional neural network with a uniform design paradigm. The high-level computer vision task includes object detection, image segmentation, image classification, and the like.

A target neural network for executing an object detection task may include a backbone network, a multi-level feature extraction network, and a prediction network, and the prediction network includes a region proposal network and a head prediction network. Therefore, an initial search space of the backbone network, an initial search space of the multi-level feature extraction network, an initial search space of the region proposal network, and an initial search space of the head prediction network can be constructed. In addition, an initial search space of resolution of an input image in the backbone network can be constructed.

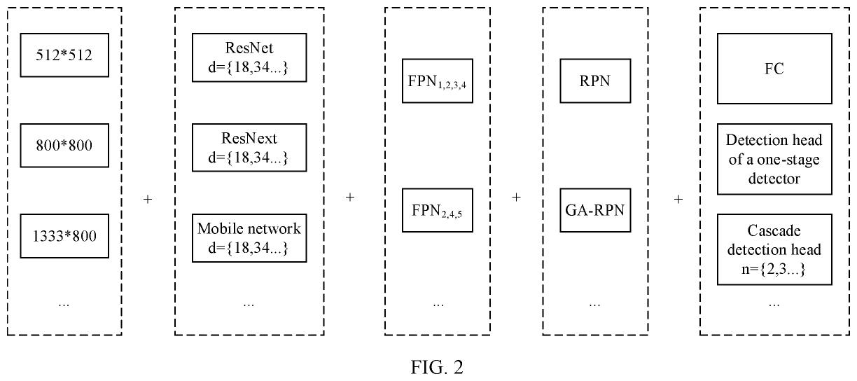

As shown in FIG. 2, the initial search space of resolution of the input image may include 512×512, 800×600, 1333×800, and the like. The initial search space of the backbone network may include ResNets of depths of 18, 34 (that is, d=18, 34 . . . ) or higher, ResNexts of depths of 18, 34, or higher, and MobileNets. The initial search space of the multi-level feature extraction network may include fusion paths of different scales in the backbone network, for example, include fusing feature pyramid networks FPN_{1,2,3,4} in which corresponding features whose resolution scales are reduced by 1, 2, 3, and 4 folds compared with those of an original image in the backbone network, and feature pyramid networks FPN_{2,4,5} in which corresponding features whose resolution scales are reduced by 2, 4, and 5 folds. The initial search space of the region proposal network may include a common region proposal network and a guided anchoring region proposal network (region proposal by guided anchoring, GA-RPN). The initial search space of the head prediction network may include a fully connected detection head (an FC detection head), a detection head of a one-stage detector, a detection head of a two-stage detector, and a cascade detection head whose quantity of concatenations, that is the number of cascade stages, is 2, 3, or the like, where n represents a quantity of concatenations.

Because a target neural network for executing an image classification task may include the backbone network and the head prediction network, the initial search space of the backbone network and the initial search space of the head prediction network may be constructed.

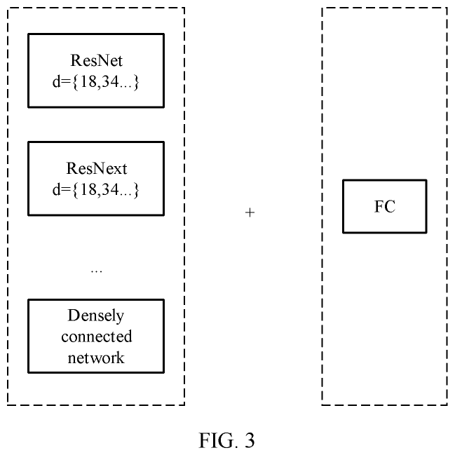

As shown in FIG. 3, the initial search space of the backbone network may include backbone networks used for classification, for example, ResNet, ResNext, and DenseNet; and the initial search space of the head prediction network may include an FC layer.

Because the target neural network for executing an image-related task may include the backbone network, the multi-level feature extraction network, and the head prediction network, the initial search space of the backbone network, the initial search space of the multi-level feature extraction network, and the initial search space of the head prediction network may be constructed.

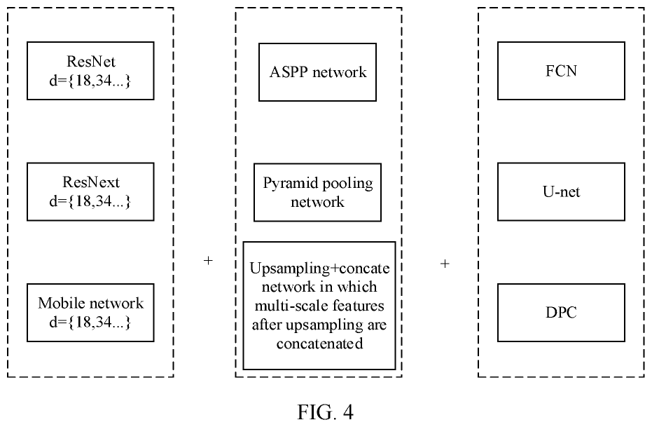

As shown in FIG. 4, the initial search space of the backbone network may include ResNet, ResNext, and a VGG network proposed by the visual geometry group (visual geometry group) from the university of Oxford. The initial search space of the multi-level feature extraction network may include an ASPP network, a pyramid pooling (pyramid pooling) network, and an upsampling+concate (upsampling+concate) network in which multi-scale features after upsampling are concatenated. The initial search space of the head prediction network may include a U-Net model, a fully convolutional network (fully convolutional networks, FCN), and a dense prediction cell (DPC) network.

In FIG. 2 to FIG. 4, “+” represents a connection relationship after sampling is performed for a neural network in the search space.

S120: Determine M candidate neural networks based on the plurality of initial search spaces, where the candidate neural network includes a plurality of candidate subnetworks, the plurality of candidate subnetworks belong to the plurality of initial search spaces, any two of the plurality of candidate subnetworks belong to different initial search spaces, and M is a positive integer.

For example, sampling may be performed for one random neural network in each initial search space, and all neural networks obtained through sampling form a complete neural network. The complete neural network is referred to as a candidate neural network.

For another example, sampling may be performed for one random neural network in each initial search space, and all neural networks obtained through sampling form a complete neural network, and then floating-point operations per second (floating-point operations per second, FLOPS) of the complete neural network are calculated. If the FLOPS of the complete neural network meets a task requirement, the complete neural network is determined as a candidate neural network. If the FLOPS of the complete neural network does not meet the task requirement, the complete neural network is discarded and sampling is performed again.

For example, when a finally determined target neural network is used on a terminal device with relatively low computing capability, the FLOPS of the complete neural network generally cannot exceed the computing capability of the terminal device. Otherwise, it is meaningless to use the neural network to execute a task on the terminal device.

If a network structure of a complete neural network obtained through sampling each time is the same as a network structure of the complete neural network obtained through previous sampling, the complete neural network obtained through current sampling may be discarded, and sampling is performed again.

Optionally, sampling may be performed on some search spaces to obtain a candidate neural network model. The candidate neural network obtained through sampling in this manner may include only neural networks in the some search spaces.

Sampling is performed on the plurality of initial search spaces for a plurality of times, for example, sampling is performed for at least M times, to obtain the M candidate neural networks.

S130: Evaluate the M candidate neural networks to obtain M evaluation results of the M candidate neural networks.

For example, a network parameter in each of the M candidate neural networks is initialized; training data is input into each candidate neural network, to train each candidate neural network, so as to obtain M trained candidate neural networks. After the M trained candidate neural networks are obtained, test data is input into the M trained candidate neural networks, to obtain the evaluation results of the M candidate neural networks.

If the candidate subnetwork in the candidate neural network has been trained before forming the candidate neural network, when the network parameter in the candidate subnetwork is initialized, a network parameter obtained through previous training in the candidate subnetwork may be loaded, to complete initialization. This can improve efficiency of training the candidate neural network, and ensure convergence of the candidate neural network.

For example, when the candidate subnetwork is ResNet that has been trained by using an ImageNet dataset, a network parameter obtained by training the ResNet by using the ImageNet dataset may be loaded.

The ImageNet dataset is a public dataset used in the ImageNet large scale visual recognition challenge (ImageNet large scale visual recognition challenge, ILSVRC) contest.

Certainly, the network parameter in the candidate neural network may alternatively be initialized in another manner. For example, the network parameter in the candidate neural network is randomly generated.

The evaluation result of the candidate neural network may include one or more of the following: an operating speed, accuracy, a quantity of parameters, or floating-point operations of the candidate neural network. Accuracy is accuracy of a task result, compared with an expected result, obtained by executing a corresponding task after test data is input into the candidate neural network.

Usually, a quantity of training times of the candidate neural network may be less than a common quantity of training times of the neural network in the field, a learning rate in each time of training of the candidate neural network may be less than a common learning rate of the neural network in the field, and training duration of the candidate neural network may be less than common training duration of the neural network in the field. In other words, the candidate neural network is trained quickly.

S140: Determine N candidate neural networks from the M candidate neural networks based on the M evaluation results, and determine N first target neural networks based on the N candidate neural networks, where each of the N candidate neural networks includes a plurality of candidate subnetworks, each of the N first target neural networks includes a plurality of target subnetworks, the N first target neural networks are in a one-to-one correspondence with the N candidate neural networks in the M candidate neural networks, the plurality of target subnetworks included in each first target neural network are in a one-to-one correspondence with a plurality of candidate subnetworks included in a corresponding candidate neural network, a block included in each target subnetwork in each first target neural network is the same as a block included in a corresponding candidate subnetwork, and N is a positive integer less than or equal to M.

A connection relationship between the target subnetworks in the first target neural network is the same as a connection relationship between corresponding candidate subnetworks in the candidate subnetwork.

That the block included in each target subnetwork is the same as the block included in the corresponding candidate subnetwork may include the following: Basic atoms in the block included in each target subnetwork and basic atoms in the block included in the corresponding candidate subnetwork have a same quantity and a same connection relationship between the basic atoms. For example, the candidate subnetwork is a multi-level feature extraction module, which is specifically a feature pyramid network, and when the feature pyramid network performs fusion with scales 2, 3, and 4, the corresponding target subnetwork still performs fusion with the scales 2, 3, and 4. For another example, when the candidate subnetwork is a prediction module, and the prediction module includes a head prediction network whose quantity of concatenations is 2, the target subnetwork still includes the head prediction network whose quantity of concatenations is 2.

It may be understood that one or more of a quantity of stacking times of the block, a quantity of channels of the block, an upsampling location, a downsampling location of a feature map, or a size of a convolution kernel in each target subnetwork may be different from a quantity of stacking times of the block, a quantity of channels of the block, an upsampling location, a downsampling location of a feature map, or a size of a convolution kernel in the corresponding candidate subnetwork.

In some possible implementations, the determining N candidate neural networks from the M candidate neural networks based on the M evaluation results, and determining N first target neural networks based on the N candidate neural networks may include: determining, based on the M evaluation results, N candidate neural networks whose evaluation results meet the task requirement in the M candidate neural networks as the N candidate neural networks, and determining the N candidate neural networks as the N first target neural networks.

For example, N candidate neural networks whose operating speeds and/or accuracy meet/meets a preset task requirement in the M candidate neural networks are determined as the N candidate neural networks, and the N candidate neural networks are determined as the N first target neural networks.

After obtaining the candidate neural network from the plurality of initial search spaces through sampling, an entire candidate neural network is evaluated, and then the first target neural network is determined based on an evaluation result and the candidate neural network. Compared with a manner of determining the first target neural network based on evaluation results of candidate subnetworks after the candidate subnetworks are evaluated separately, in the manner of determining the first target neural network based on the evaluation result of the entire candidate neural network after the candidate neural network is obtained through sampling, a combination mode between the candidate subnetworks is fully considered, and the first target neural network with better performance may be obtained. Therefore, better completion quality may be achieved when a task is executed by using the first target neural network.

In some possible implementations, the evaluation result of the candidate neural network may include the operating speed and accuracy. In the implementations, the determining N candidate neural networks from the M candidate neural networks based on the M evaluation results, and determining N first target neural networks based on the N candidate neural networks may include: determining Pareto optimal solutions of the M candidate neural networks as the N candidate neural networks based on the M evaluation results and by using the operating speed and accuracy as an objective, and determining the N first target neural networks based on the N candidate neural networks.

Because the N candidate neural networks obtained in this implementation are the Pareto optimal solutions of the M candidate neural networks, performance of the N candidate neural networks is better than performance of other candidate neural networks, and performance of the N first target neural networks determined based on the N candidate neural networks is also better.

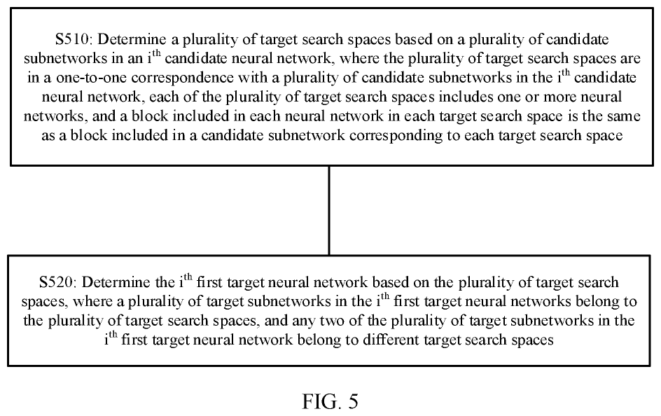

The evaluation result of the candidate neural network includes the operating speed and prediction accuracy. When the operating speed is used as a horizontal coordinate and the prediction accuracy is used as a vertical coordinate, a spatial location relationship of the M candidate neural networks is shown in FIG. 5. The dashed line represents a Pareto front of a plurality of first candidate neural networks, a first candidate neural network located on the dashed line is a Pareto optimal solution, and a set of all first candidate neural networks located on the dashed line is a Pareto optimal set.

After a new first candidate neural network and an evaluation result of the new first candidate neural network are determined based on M initial search spaces each time, a Pareto front of the first candidate neural networks is redetermined based on a spatial location relationship between the evaluation result and a previous evaluation result of the first candidate neural network. In other words, the Pareto optimal set of the first candidate neural networks is updated.

In this embodiment, when the N first target neural networks are determined based on the N candidate neural networks, an i^{th} first target neural network in the N first target neural networks may be determined based on an i^{th} candidate neural network in the N candidate neural networks, where i is a positive integer less than or equal to N.

In some possible implementations, the determining an i^{th} first target neural network based on an i^{th} candidate neural network may include: determining the i^{th} candidate neural network as the i^{th} first target neural network.

An example flowchart of another implementation of determining the i^{th} first target neural network based on the i^{th} candidate neural network is shown in FIG. 5. The method may include S510 and S520.

S510: Determine a plurality of target search spaces based on a plurality of candidate subnetworks in an i^{th} candidate neural network, where the plurality of target search spaces are in a one-to-one correspondence with a plurality of candidate subnetworks in the i^{th} candidate neural network, each of the plurality of target search spaces includes one or more neural networks, and a block included in each neural network in each target search space is the same as a block included in a candidate subnetwork corresponding to each target search space.

Specifically, a target search space corresponding to each candidate subnetwork in the plurality of candidate subnetworks is determined based on the candidate subnetwork, to finally obtain the plurality of target search spaces. Each target search space may include one or more neural networks, but generally at least one target search space includes a plurality of neural networks.

During the determining of the plurality of target search spaces based on the plurality of candidate subnetworks in the i^{th} candidate neural network, a corresponding target search space may be determined based on each candidate subnetwork. For example, the target search space is determined based on a structure of a block included in each candidate subnetwork.

In some implementations, the candidate subnetwork may be directly used as a target search space corresponding to the candidate subnetwork. In this case, the target search space includes only one neural network. In other words, the candidate subnetwork is directly used as a target subnetwork and remains unchanged. A target subnetwork corresponding to another candidate subnetwork in the i^{th} candidate neural network is searched for, and then all target subnetworks form the target neural network.

In some other implementations, a corresponding target search space may be constructed based on the candidate subnetwork, where the target search space includes a plurality of target subnetworks, and a block included in each target subnetwork in the target search space is the same as a block included in the candidate subnetwork.

In this case, that the block included in each target subnetwork is the same as the block included in the candidate subnetwork may be understood as including the following: Basic atoms in the block included in each target subnetwork and basic atoms in the block included in the corresponding candidate subnetwork have a same quantity and a same connection relationship between the basic atoms. For example, the candidate subnetwork is a multi-level feature extraction module, which is specifically a feature pyramid network, and when the feature pyramid network performs fusion with scales 2, 3, and 4, the corresponding target subnetwork still performs fusion with the scales 2, 3, and 4. For another example, when the candidate subnetwork is a prediction module, and the prediction module includes a head prediction network whose quantity of concatenations is 2, the target subnetwork still includes the head prediction network whose quantity of concatenations is 2.

It may be understood that one or more of a quantity of stacking times of the block, a quantity of channels of the block, an upsampling location, a downsampling location of a feature map, or a size of a convolution kernel in each target subnetwork may be different from a quantity of stacking times of the block, a quantity of channels of the block, an upsampling location, a downsampling location of a feature map, or a size of a convolution kernel in the corresponding candidate subnetwork.

S520: Determine the i^{th} first target neural network based on the plurality of target search spaces, where a plurality of target subnetworks in the i^{th} first target neural network belong to the plurality of target search spaces, and any two of the plurality of target subnetworks in the i^{th} first target neural network belong to different target search spaces.

For example, one target subnetwork is selected from each target search space, and then all selected target subnetworks are combined into a complete neural network.

When selecting the target subnetwork from each target search space, a neural network may be randomly selected as the target subnetwork. Alternatively, a quantity of parameters of each neural network in the target search space may be calculated first, and then a neural network with a smaller quantity of parameters may be selected as the target subnetwork. Certainly, the target subnetwork may be selected in another manner. For example, a method for searching for a neural network in a conventional technology is used to select the target subnetwork. This is not limited in this embodiment.

After the complete neural network is obtained, in an implementation, FLOPS of the neural network may be calculated. When the FLOPS of the neural network meets the task requirement, the complete neural network is used as the first target neural network.

After the method shown in FIG. 5 is performed for each of the N candidate neural networks, the N first target neural networks may be obtained.

In this embodiment, after the N first target neural networks are determined, the N first target neural networks may be evaluated to obtain N evaluation results of the N first target neural networks, and the N evaluation results are stored, so that a user can determine, based on the N evaluation results, first target neural networks that meet the task requirement, to determine whether specific first target neural networks need to be selected.

An evaluation result of each first target neural network may include one or more of the following: an operating speed, accuracy, or a quantity of parameters. Accuracy is accuracy of a task result, compared with an expected result, obtained by executing a corresponding task after test data is input into the first target neural network.

An implementation of evaluating the first target neural network may include: initializing a network parameter in the first target neural network; inputting training data to the first target neural network, and training the first target neural network; and inputting test data to the trained first target neural network, to obtain an evaluation result of the first target neural network.

In this embodiment, a quantity of training times of the first target neural network may be greater than a quantity of training times of the candidate neural network, a learning rate in each time of training of the first target neural network may be greater than a learning rate in each time of training of the candidate neural network, and training duration of the first target neural network may be less than common training duration of the candidate neural network. In this way, a target neural network with higher accuracy can be obtained through training.

In this embodiment, after the N first target neural networks are obtained, in a first implementation, a group normalization (group normalization, GN) layer may be added after each convolutional layer and/or each fully connected layer in each target subnetwork in the first target neural network, to obtain a second target neural network corresponding to the first target neural network. Performance and a training speed of the second target neural network are improved compared with those of the first target neural network. If a batch normalization (batch normalization, BN) layer originally exists in the target subnetwork, the BN layer may be replaced with a GN layer.

For example, the first target neural network is a convolutional neural network used to execute a computer vision task, and the convolutional neural network is a neural network including a backbone network module, a multi-level feature extraction module, and a prediction module. In this case, a BN layer in the backbone network module may be replaced with a GN layer, and a GN layer is added after each convolutional layer and each fully connected layer in the multi-level feature extraction module and the prediction module, to obtain a corresponding second target neural network.

Because the computer vision task requires an input image of a large size, but a capacity of a video random access memory of a graphics processing unit (graphics processing unit, GPU) used for training is limited, small input batches (that is, a small quantity of images is input at one time) are usually used in a training process. This causes inaccurate statistics (means and variances) of input data estimated by using a BN-related policy, and consequently reduces accuracy of a trained first target neural network. The GN is insensitive to a batch size. Therefore, statistics of the input data can be better estimated, thereby improving performance and the training speed of the second target neural network.

In this embodiment of this application, after the N first target neural networks are obtained, in a second implementation, weights of all convolutional layers in each first target neural network may be standardized (weight standardization, WS), to obtain a corresponding second target neural network. In other words, in addition to standardizing an activation function, the weights of the convolutional layers are standardized to increase the training speed and avoid dependence on a size of an input batch.

Standardizing the weight of the convolutional layer may also be referred to as normalizing the convolutional layer. For example, normalization processing may be performed on the convolutional layer by using the following formula:

$$\hat{W} = [ {\hat{W}}_{i , j} \vert {\hat{W}}_{i , j} = \frac{{W}_{i , j} - μ {W}_{i , j}}{σ {W}_{i , j + e}} ] , \hat{W} ∈ {R}^{O \times I} \\ y = \hat{W} * x \\ μ {W}_{i , j} = \frac{1}{I} {\sum }_{j = 1}^{I} {W}_{i , j} \\ σ {W}_{i , j + e} = \sqrt{\frac{1}{I} {\sum }_{j = 1}^{I} {( {W}_{i , j} - μ {W}_{i , j} )}^{2}} \\ I = {C}_{i n} \times K$$

Ŵ represents a weight matrix of the convolutional layer, * represents a convolution operation, O represents a quantity of output channels, Cᵢₙ represents a quantity of input channels, I represents a quantity of input channels of each output channel within a convolution kernel region, x represents input of the convolutional layer, y represents output of the convolutional layer, Ŵ_{i,j} represents a weight an input channel in a j^{th} convolution kernel region corresponding to an i^{th} output channel, and K represents a size of the convolution kernel.

For example, when the first target neural network is a convolutional neural network used to execute a computer vision task, a plurality of loss functions usually need to be optimized in a training process of the convolutional neural network. For example, when the first target neural network is a convolutional neural network used for object detection, it is necessary to optimize a classification loss function and a bounding box regression loss function in the foreground and background in the region proposal network and a classification loss function and a bounding box regression loss function of a specific category in the head prediction network. Complexity of these loss functions prevents gradients of the loss functions from back-propagating to the backbone network. However, standardization performed on the weights of the convolutional layers can make each loss function smoother, and help the gradients of the loss functions back-propagate to the backbone network. This may improve performance and the training speed of the corresponding second target neural network.

In this embodiment of this application, after the N first target neural networks are obtained, in a third implementation, weights of all convolutional layers in each first target neural network may be standardized. Further, a group normalization layer is added after each convolutional layer and each fully connected layer in each target subnetwork in the first target neural network.

In this embodiment, after N second target neural networks are obtained, evaluation results of the N second target neural networks may be obtained. For an obtaining manner, refer to a manner of obtaining the evaluation result of the first target neural network. Details are not described herein again.

In this embodiment, after the candidate neural network and the evaluation result of the candidate neural network are obtained, the Pareto optimal set of the candidate neural networks may be updated based on the evaluation result.

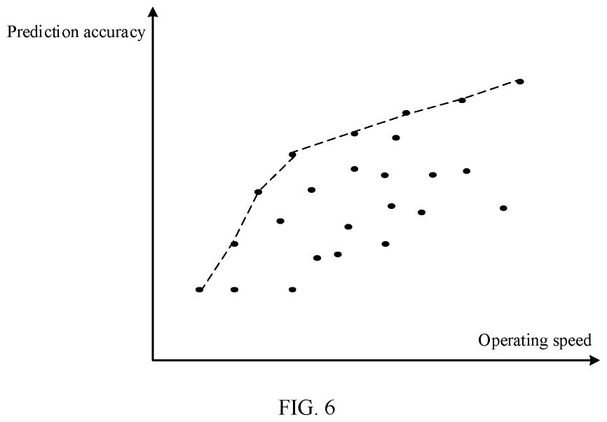

When the evaluation result of the candidate neural network includes the operating speed and prediction accuracy, a two-dimensional spatial coordinate system is constructed by using the operating speed as a horizontal coordinate and using prediction accuracy as a vertical coordinate. A spatial location relationship of a plurality of candidate neural networks obtained by performing S120 and S130 for a plurality of times is shown in FIG. 6. A dot represents an evaluation result of a candidate neural network, the dashed line represents a Pareto front of the plurality of candidate neural networks, a candidate neural network located on the dashed line is a Pareto optimal solution, and a set of all candidate neural networks located on the dashed line is a Pareto optimal set.

After a new candidate neural network and an evaluation result of the new candidate neural network are determined each time, a Pareto front of the candidate neural networks is redetermined based on a spatial location relationship between the evaluation result and a previous evaluation result of the candidate neural network. In other words, the Pareto optimal set of the candidate neural networks is updated.

In some implementations, an evaluation result of the candidate neural network that is used as the Pareto optimal solution may be considered as an evaluation result that meets the task requirement, and a target neural network may be further determined based on the candidate neural network.

In some other implementations, one or more Pareto optimal solutions can be selected from the Pareto optimal set, and only evaluation results of the one or more Pareto optimal solutions are considered as evaluation results that meet the task requirement. For example, when it is required in the task requirement that an operating speed of the first target neural network be less than a threshold, only an evaluation result of a first candidate neural network, in the Pareto optimal set, whose operating speed is less than the threshold is an evaluation result that meets the task requirement.

For a candidate neural network that meets the task requirement, a target search space of each candidate subnetwork in the candidate neural network is constructed, and the target search space of each candidate subnetwork is searched for a target subnetwork corresponding to the candidate subnetwork. Then, target subnetworks obtained by searching a plurality of target search spaces constitute the first target neural network.

In this embodiment, the steps in FIG. 3 may be performed on a plurality of candidate neural networks in parallel, to obtain a plurality of target neural networks corresponding to the plurality of candidate neural networks. In this way, search time can be saved and search efficiency can be improved.

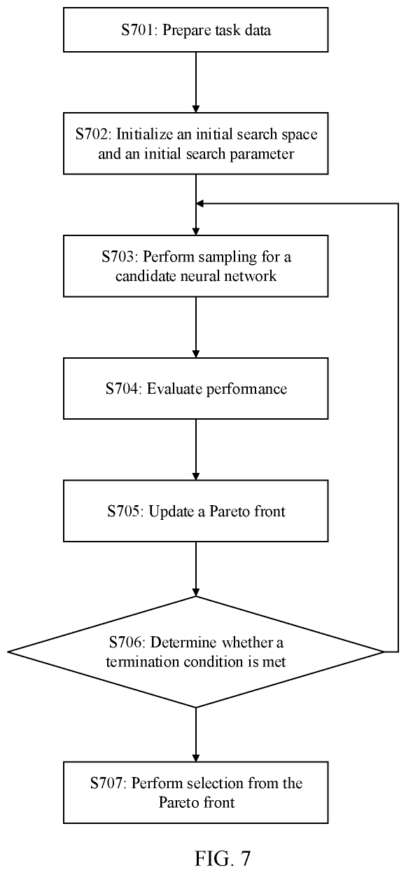

An example flowchart of a method for determining a neural network in this application is described below with reference to FIG. 7.

S701: Prepare task data. Specifically, accurate training data and test data are prepared.

S702: Initialize an initial search space and an initial search parameter.

For an implementation of initializing the initial search space, refer to the foregoing implementation of determining the initial search space. Details are not described herein again.

The initial search parameter includes a training parameter obtained during training of each candidate neural network. For example, the initial search parameter may include a quantity of training times, a learning rate, and/or training duration of each candidate neural network.

S703: Perform sampling for the candidate neural network. For an implementation of this step, refer to the foregoing implementation of determining the candidate neural network based on a plurality of initial search spaces. Details are not described herein again.

S704: Evaluate performance. For an implementation of this step, refer to the foregoing implementation of evaluating the candidate neural network. Details are not described herein again.

S705: Update a Pareto front. For this step, refer to the foregoing implementation of updating the Pareto front. Details are not described herein again.

S706: Determine whether a termination condition is met. If the termination condition is met, repeat S703; otherwise, perform S707. When the termination condition is met, a plurality of candidate neural networks may be obtained through searching.

For example, when a difference between an evaluation result of a current candidate neural network and an evaluation result of a previous candidate neural network is less than or equal to a preset threshold, it is determined that the termination condition is met.

S707: Perform selection from the Pareto front. In other words, n candidate neural networks are selected from the Pareto front obtained in S705, and the n candidate neural networks are E1 to En in order. S708 to S712 are then performed in parallel for the n candidate neural networks.

For example, n candidate neural networks whose operating speeds are less than or equal to a preset threshold are selected from the Pareto front obtained in S705.

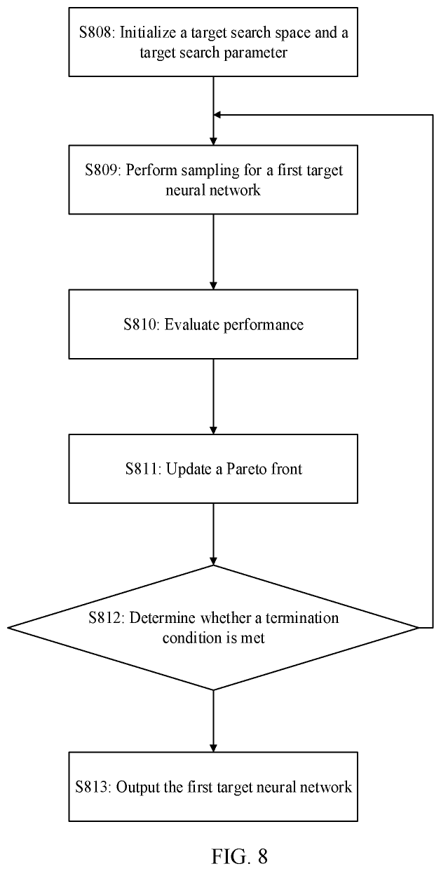

Then, a method in FIG. 8 is performed for each of the selected n candidate neural networks.

S808: Initialize a target search space and a target search parameter.

For an implementation of initializing the target search space, refer to the foregoing implementation of determining the target search space. Details are not described herein again.

The target search parameter includes a training parameter obtained during training of each first target neural network. For example, the target search parameter may include a quantity of training times, a learning rate, and/or training duration of each first target neural network.

S809: Perform sampling for the first target neural network. For an implementation of this step, refer to the foregoing implementation of determining the first target neural network based on a plurality of target search spaces. Details are not described herein again.

S810: Evaluate performance. For an implementation of this step, refer to the foregoing implementation of evaluating the first target neural network. Details are not described herein again.

S811: Update a Pareto front. The first target neural network is considered as a candidate neural network, and a Pareto front of the n candidate neural networks selected in S707 is updated based on an evaluation result of the first target neural network. For a specific updating manner, refer to the foregoing content. Details are not described herein again.

S812: Determine whether a termination condition is met. If the termination condition is met, repeat S809; otherwise, perform S813.

For example, when a difference between an evaluation result of a current first target neural network and an evaluation result of a first target neural network obtained by performing S809 last time is less than or equal to a preset threshold, it is determined that the termination condition is met.

The Pareto front shown in FIG. 6 is used as an example. After the termination condition is met, a finally updated Pareto front is shown by a solid line in FIG. 11. As shown in FIG. 11, a target neural network corresponding to the finally updated Pareto front has higher prediction accuracy under a constraint of a same operating speed.

S813: Output the first target neural network. In addition, evaluation results of n first target neural networks may be further output.

For example, the first target neural network corresponding to the Pareto front that is updated in S811 is output.

The following describes, with reference to Table 1, structures and related information of six example first target neural networks (E1 to E6) obtained by using the method in this application.

TABLE 1
Table of network structures and related information of the first target neural networks

| | | | Network structure of a | Region | Head | Floating-point | | |
|---|---|---|---|---|---|---|---|---|
| | Size of an | Network structure of a | multi-level feature | proposal | prediction | operations per | | Prediction |
| Model | input image | backbone network module | extraction module | network | network | second of the | Time | accuracy |
| E1 | 512* | basicblock_64_1- | FPN(P2-P5, | RPN | 2FC | 7.2 | 24.5 | 27.1 |
| | 512 | 21-21-12 | c = 128) | | | | | |
| E2 | 800* | basicblock_48_12- | FPN(P1-P5, | RPN | 2FC | 28.3 | 32.2 | 34.3 |
| | 600 | 21-11111-2111111 | c = 256) | | | | | |
| E3 | 800* | basicblock_56_12- | FPN(P1-P5, | RPN | Cascade | 23.8 | 39.5 | 40.1 |
| | 600 | 11111-211-1112 | c = 128) | | (n = 3) | | | |
| E4 | 800* | basicblock_56_211- | FPN(P1-P5, | RPN | Cascade | 59.2 | 50.7 | 42.7 |
| | 600 | 111111111-2111111- | c = 256) | | (n = 3) | | | |
| | | 11112111 | | | | | | |
| E5 | 800* | ResNextblock_56_21- | FPN6.11(P1-P5, | GA- | Cascade | 73.5 | 80.2 | 43.9 |
| | 600 | 21-1111111111 | c = 256) | RPN | (n = 3) | | | |
| | | 11111-2111111 | | | | | | |
| E6 | 1333 + | ResNextblock_56_21- | FPN(P1-P5, | GA- | Cascade | 162.45 | 108.1 | 46.1 |
| | 800 | 21-1111111111 | c = 256) | RPN | (n = 3) | | | |
| | | 1111-21111111 | | | | | | |

In Table 1, mAP represents an average accuracy rate of an object detection prediction result. For the backbone network module, the first placeholder is selected by a convolution module. The second placeholder is a quantity of basic channels. “−” separates stages with different resolution, and resolution of a current stage is reduced by half compared with resolution of a previous stage. “1” represents a regular block for which channels do not change, and “2” indicates that a quantity of basic channels in the block is doubled. For the network structure of the multi-level feature extraction module (Neck), P1-P5 represents a hierarchy of features selected from the backbone network module and “c” represents a quantity of channels output by the Neck. For an RCNN header, “2FC” represents two shared fully connected layers; “n” represents a quantity of concatenations of a head prediction network; time is processing time after each image is input into the first target neural network, and a unit is millisecond (ms). A unit of floating-point operations per second of the backbone network module is gigabyte (G).

The following describes, with reference to Table 2, an experimental result of a second target neural network obtained after weights of convolutional layers in the first target neural network are standardized and a group normalization layer is added after each convolutional layer and each fully connected layer in the first target neural network.

TABLE 2
Table of performance of neural networks obtained by using
different training methods

| Training method | Epoch | Batch | Learning rate | mAP |
|---|---|---|---|---|
| BN | 12 | 2*8 | 0.02 | 24.8 |
| BN | 12 | 8*8 | 0.20 | 28.3 |
| GN | 12 | 2*8 | 0.02 | 29.4 |
| GN + WS | 12 | 4*8 | 0.02 | 30.7 |

A backbone network module of the first target neural network is of a ResNet-50 structure. The multi-level feature extraction module is a feature pyramid network. The head prediction module includes two FC layers. Furthermore, experimental training of effectiveness analysis is performed for the first target neural network using different strategies, and evaluation is provided on a COCO (common objects in context) dataset. The COCO dataset is a well-known dataset built by a Microsoft team in the field of object detection. Epoch indicates a quantity of training epochs (traversing a training subset once indicates one training epoch). Batch Size is a size of an input batch. Experiment 1 and experiment 2 are training procedures that follow a standard detection model and each train 12 epochs. It is found by comparing experiments 1, 2, and 3 that, an input batch of a smaller size leads to incorrect estimation of statistics of input data, which leads to a decrease in accuracy. Group normalization can alleviate this problem and increase mAP from 24.8% to 29.4%. It is found by comparing experiments 3 and 4 that, adding WS can further smooth a training process and increase mAP by 1.3%. Therefore, the method for training a detection network from scratch even ends training earlier than a method for using parameters pre-trained by the ImageNet as initial parameters.

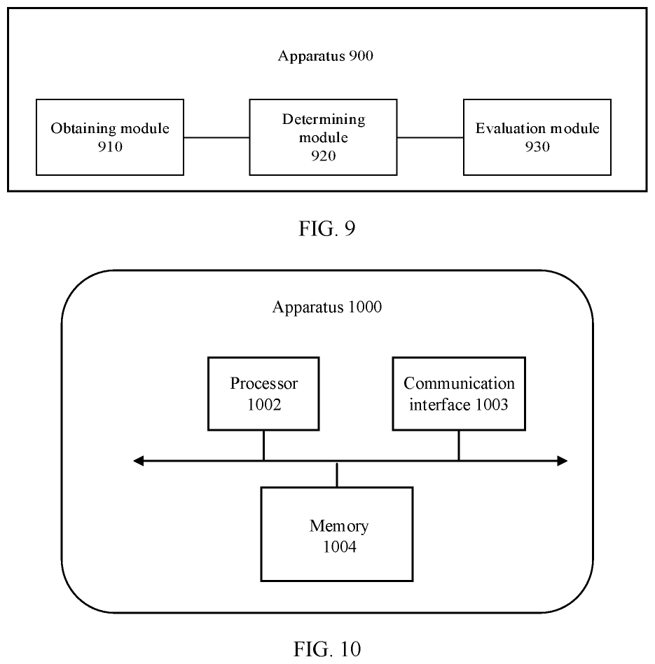

FIG. 9 is an example diagram of a structure of an apparatus for training a neural network according to this application. The apparatus 900 includes an obtaining module 910, a determining module 920, and an evaluation module 930. The apparatus 900 may implement the method shown in FIG. 1, FIG. 5, or FIG. 7.

For example, the obtaining module 910 is configured to perform S110, the determining module 220 is configured to perform S120 and S140, and the evaluation module 930 is configured to perform S130.

The apparatus 900 may be deployed in a cloud environment, and the cloud environment is an entity that provides a cloud service for a user by using a basic resource in a cloud computing mode. The cloud environment includes a cloud data center and a cloud service platform. The cloud data center includes a large quantity of basic resources (including a compute resource, a storage resource, and a network resource) owned by a cloud service provider. The compute resources included in the cloud data center may be a large quantity of computing devices (for example, servers). The apparatus 900 may be a server that is in a cloud data center and that is configured to train a neural network. Alternatively, the apparatus 900 may be a virtual machine that is created in the cloud data center and that is used to train a neural network. The apparatus 900 may alternatively be a software apparatus deployed on a server or a virtual machine in the cloud data center. The software apparatus is configured to train a neural network. The software apparatus may be deployed on a plurality of servers in a distributed manner, or deployed on a plurality of virtual machines in a distributed manner, or deployed on virtual machines and servers in a distributed manner. For example, the obtaining module 910, the determining module 920, and the evaluation module 930 in the apparatus 900 may be deployed on a plurality of servers in a distributed manner, or deployed on a plurality of virtual machines in a distributed manner, or deployed on virtual machines and servers in a distributed manner. For another example, when the determining module 920 includes a plurality of submodules, the plurality of submodules may be deployed on a plurality of servers, or deployed on a plurality of virtual machines in a distributed manner, or deployed on virtual machines and servers in a distributed manner.

The apparatus 900 may be abstracted, by a cloud service provider on a cloud service platform, into a cloud service for determining a neural network and provided to the user. After the user purchases the cloud service on the cloud service platform, the cloud environment provides a cloud service for determining a neural network to the user by using the cloud service. The user may upload a task requirement to the cloud environment through an application programing interface (application program interface, API) or a web page interface provided by the cloud service platform. The apparatus 900 receives the task requirement, determines a neural network used to implement the task, and returns, via the apparatus 900, a finally obtained neural network to an edge device at which the user is located.

When the apparatus 900 is a software apparatus, the apparatus 900 may alternatively be independently deployed on a computing device in any environment.

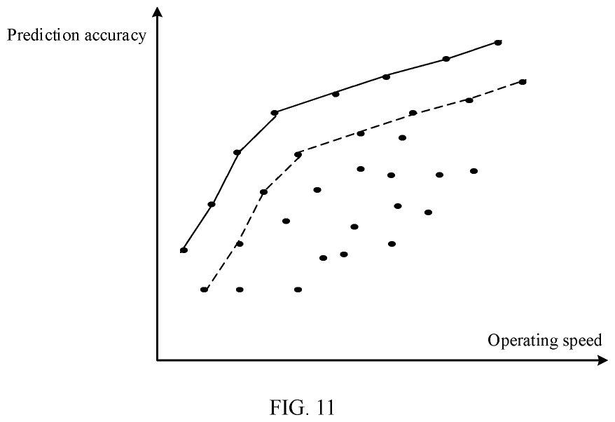

This application further provides an apparatus 1000 shown in FIG. 10. The apparatus 1000 includes a processor 1002, a communication interface 1003, and a memory 1004. One example of the apparatus 1000 is a chip. Another example of the apparatus 1000 is a computing device.

The processor 1002, the memory 1004, and the communication interface 1003 communicate with each other through a bus. The memory 1004 stores executable code, and the processor 1002 reads the executable code in the memory 1004 to perform a corresponding method. The memory 1004 may further include another software module, for example, an operating system, for running a process. The operating system may be LINUX™ UNIX™ WINDOWS™, or the like.

For example, the executable code in the memory 1004 is used to implement the method shown in FIG. 1, and the processor 1002 reads the executable code in the memory 1004 to perform the method shown in FIG. 1.

The processor 1002 may be a central processing unit (central processing unit, CPU). The memory 1004 may include a volatile memory (volatile memory), for example, a random access memory (random access memory, RAM). The memory 1004 may further include a non-volatile memory (non-volatile memory, NVM), for example, a read-only memory (read-only memory, ROM), a flash memory, a hard disk drive (hard disk drive, HDD), or a solid state disk (solid state disk, SSD).

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in another manner. For example, the described apparatus embodiments are merely examples. For example, division into units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or another form.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of this application. The foregoing storage medium includes various media that can store program code, such as a USB flash drive, a removable hard disk, a read-only memory (Read-Only Memory, ROM), a random access memory (Random Access Memory, RANI), a magnetic disk, and an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method for determining a neural network, comprising:
obtaining a plurality of initial search spaces, wherein the initial search space comprises one or more neural networks, neural networks in any two of the initial search spaces have different functions, and any two neural networks in a same initial search space have a same function but different network structures;
determining M candidate neural networks based on the plurality of initial search spaces, wherein the candidate neural network comprises a plurality of candidate subnetworks, the plurality of candidate subnetworks belong to the plurality of initial search spaces, any two of the plurality of candidate subnetworks belong to different initial search spaces, and M is a positive integer;
evaluating the M candidate neural networks to obtain M evaluation results; and
determining N candidate neural networks from the M candidate neural networks based on the M evaluation results, and determining N first target neural networks based on the N candidate neural networks, wherein each of the N candidate neural networks comprises a plurality of candidate subnetworks, each of the N first target neural networks comprises a plurality of target subnetworks, the N first target neural networks are in a one-to-one correspondence with the N candidate neural networks, the plurality of target subnetworks comprised in each first target neural network are in a one-to-one correspondence with a plurality of candidate subnetworks comprised in a corresponding candidate neural network, a block comprised in each target subnetwork in each first target neural network is the same as a block comprised in a corresponding candidate subnetwork, and N is a positive integer less than or equal to M.

2. The method according to claim 1, wherein the evaluation result of the candidate neural network comprises one or more of the following: an operating speed, accuracy, a quantity of parameters, or floating-point operations per second.

3. The method according to claim 2, wherein the evaluation result of the candidate neural network comprises the operating speed and accuracy; and
the determining N candidate neural networks from the M candidate neural networks based on the M evaluation results comprises:
determining Pareto optimal solutions of the M candidate neural networks as the N candidate neural networks based on the M evaluation results and by using the operating speed and accuracy as an objective.

4. The method according to claim 3, wherein the determining N first target neural networks based on the N candidate neural networks comprises:
determining a plurality of target search spaces based on a plurality of candidate subnetworks in an i^{th} candidate neural network in the N candidate neural networks, wherein the plurality of target search spaces are in a one-to-one correspondence with the plurality of candidate subnetworks in the i^{th} candidate neural network, each of the plurality of target search spaces comprises one or more neural networks, and a block comprised in each neural network in each target search space is the same as a block comprised in a candidate subnetwork corresponding to each target search space; and
determining an i^{th} first target neural network in the N first target neural networks based on the plurality of target search spaces, wherein a plurality of target subnetworks in the i^{th} first target neural network belong to the plurality of target search spaces, any two of the plurality of target subnetworks in the i^{th} first target neural network belong to different target search spaces, and i is a positive integer less than or equal to N.

5. The method according to claim 1, wherein the method further comprises:
determining N second target neural networks based on the N first target neural networks, wherein an i^{th} second target neural network in the N second target neural networks is obtained by performing one or more of the following processing on the i^{th} first target neural network: adding a group normalization layer after a convolutional layer in the target subnetwork in the i^{th} first target neural network; adding a group normalization layer after a fully connected layer in the target subnetwork in the i^{th} first target neural network; and performing normalization processing on a weight of the convolutional layer in the target subnetwork in the i^{th} first target neural network, wherein i is a positive integer less than or equal to N.

6. The method according to claim 5, wherein the method further comprises:
evaluating the N second target neural networks to obtain evaluation results of the N second target neural networks.

7. The method according to claim 6, wherein the evaluating the N second target neural networks to obtain evaluation results of the N second target neural networks comprises:
randomly initializing a network parameter in the i^{th} second target neural network;
training the i^{th} second target neural network based on training data; and
testing the i^{th} trained second target neural network based on test data, to obtain an evaluation result of the i^{th} trained second target neural network.

8. The method according to claim 1, wherein the first target neural network is used for object detection; the plurality of initial search spaces comprise a first initial search space, a second initial search space, a third initial search space, and a fourth initial search space; the first initial search space comprises at least one of residual networks of different depths, next-dimension residual networks of different depths, and mobile networks of different depths; the second initial search space comprises a connection path of features at different levels; the third initial search space comprises at least one of a common region proposal network and a guided anchoring region proposal network; and the fourth initial search space comprises at least one of a one-stage detection head network, a fully connected detection head network, a fully convolutional detection head network, and a cascade detection head network.

9. The method according to claim 1, wherein the first target neural network is used for image classification; the plurality of initial search spaces comprise a first initial search space and a second initial search space, the first initial search space comprises at least one of residual networks of different depths, next-dimension residual networks of different depths, and densely connected networks of different widths; and a neural network in the second initial search space comprises a fully connected layer.

10. The method according to claim 1, wherein the first target neural network is used for image segmentation; the plurality of initial search spaces comprise a first initial search space, a second initial search space, and a third initial search space; the first initial search space comprises at least one of residual networks of different depths, next-dimension residual networks of different depths, and high-resolution networks of different widths; the second initial search space comprises at least one of an atrous spatial pyramid pooling network, a pyramid pooling network, and a network comprising a dense prediction unit; and the third initial search space comprises at least one of a U-Net model and a fully convolutional network.

11. An apparatus for determining a neural network, comprising:
an obtaining module, configured to obtain a plurality of initial search spaces, wherein the initial search space comprises one or more neural networks, neural networks in any two of the initial search spaces have different functions, and any two neural networks in a same initial search space have a same function but different network structures;
a determining module, configured to determine M candidate neural networks based on the plurality of initial search spaces, wherein the candidate neural network comprises a plurality of candidate subnetworks, the plurality of candidate subnetworks belong to the plurality of initial search spaces, any two of the plurality of candidate subnetworks belong to different initial search spaces, and M is a positive integer; and
an evaluation module, configured to evaluate the M candidate neural networks to obtain M evaluation results, wherein
the determining module is further configured to: determine N candidate neural networks from the M candidate neural networks based on the M evaluation results, and determine N first target neural networks based on the N candidate neural networks, wherein each of the N candidate neural networks comprises a plurality of candidate subnetworks, each of the N first target neural networks comprises a plurality of target subnetworks, the N first target neural networks are in a one-to-one correspondence with the N candidate neural networks in the M candidate neural networks, the plurality of target subnetworks comprised in each first target neural network are in a one-to-one correspondence with a plurality of candidate subnetworks comprised in a corresponding candidate neural network, a block comprised in each target subnetwork in each first target neural network is the same as a block comprised in a corresponding candidate subnetwork, and N is a positive integer less than or equal to M.

12. The apparatus according to claim 11, wherein the evaluation result of the candidate neural network comprises one or more of the following: an operating speed, accuracy, a quantity of parameters, or floating-point operations per second.

13. The apparatus according to claim 12, wherein the evaluation result of the candidate neural network comprises the operating speed and accuracy; and
the determining module is specifically configured to:
determine Pareto optimal solutions of the M candidate neural networks as the N candidate neural networks based on the M evaluation results and by using the operating speed and accuracy as an objective.

14. The apparatus according to claim 13, wherein the determining module is specifically configured to:
determine a plurality of target search spaces based on a plurality of candidate subnetworks in an i^{th} candidate neural network in the N candidate neural networks, wherein the plurality of target search spaces are in a one-to-one correspondence with the plurality of candidate subnetworks in the i^{th} candidate neural network, each of the plurality of target search spaces comprises one or more neural networks, and a block comprised in each neural network in each target search space is the same as a block comprised in a candidate subnetwork corresponding to each target search space; and
determine an i^{th} first target neural network in the N first target neural networks based on the plurality of target search spaces, wherein a plurality of target subnetworks in the i^{th} first target neural network belong to the plurality of target search spaces, any two of the plurality of target subnetworks in the i^{th} first target neural network belong to different target search spaces, and i is a positive integer less than or equal to N.

15. The apparatus according to claim 11, wherein the determining module is further configured to:
determine N second target neural networks based on the N first target neural networks, wherein an i^{th} second target neural network in the N second target neural networks is obtained by performing one or more of the following processing on the i^{th} first target neural network: adding a group normalization layer after a convolutional layer in the target subnetwork in the i^{th} first target neural network; adding a group normalization layer after a fully connected layer in the target subnetwork in the i^{th} first target neural network; and performing normalization processing on a weight of the convolutional layer in the target subnetwork in the i^{th} first target neural network, wherein i is a positive integer less than or equal to N.

16. The apparatus according to claim 15, wherein the evaluation module is further configured to:
evaluate the N second target neural networks to obtain evaluation results of the N second target neural networks.

17. The apparatus according to claim 16, wherein the evaluation module is specifically configured to:
randomly initialize a network parameter in the i^{th} second target neural network;
train the i^{th} second target neural network based on training data; and
test the i^{th} trained second target neural network based on test data, to obtain an evaluation result of the i^{th} trained second target neural network.

18. The apparatus according to claim 11, wherein the first target neural network is used for object detection; the plurality of initial search spaces comprise a first initial search space, a second initial search space, a third initial search space, and a fourth initial search space; the first initial search space comprises at least one of residual networks of different depths, next-dimension residual networks of different depths, and mobile networks of different depths; the second initial search space comprises a connection path of features at different levels; the third initial search space comprises at least one of a common region proposal network and a guided anchoring region proposal network; and the fourth initial search space comprises at least one of a one-stage detection head network, a fully connected detection head network, a fully convolutional detection head network, and a cascade detection head network.

19. The apparatus according to claim 11, wherein the first target neural network is used for image classification; the plurality of initial search spaces comprise a first initial search space and a second initial search space, the first initial search space comprises at least one of residual networks of different depths, next-dimension residual networks of different depths, and densely connected networks of different widths; and a neural network in the second initial search space comprises a fully connected layer.

20. The apparatus according to claim 11, wherein the first target neural network is used for image segmentation; the plurality of initial search spaces comprise a first initial search space, a second initial search space, and a third initial search space; the first initial search space comprises at least one of residual networks of different depths, next-dimension residual networks of different depths, and high-resolution networks of different widths; the second initial search space comprises at least one of an atrous spatial pyramid pooling network, a pyramid pooling network, and a network comprising a dense prediction unit; and the third initial search space comprises at least one of a U-Net model and a fully convolutional network.

21. An apparatus for determining a neural network, comprising:
a memory, configured to store a program; and
a processor, configured to execute the program stored in the memory, wherein when the program stored in the memory is executed, the method according to claim 1 is implemented.

22. A computer-readable storage medium, wherein the computer-readable medium stores instructions executable by a computing device, and when the computing device executes the instructions, the method according to claim 1 is implemented.
